(19) United States
(12) Patent Application Publication
(10) Pub. No.: US 2008/0159210 A1
(43) Pub. Date: Jul. 3, 2008

(54) System and method for automatic channel selection

(75) Inventors: Artur Zaks, Modiin (IL); Yehuda Azenkot, San Jose, CA (US); Raz Bareket, Tel Aviv (IL)

Correspondence Address: TEXAS INSTRUMENTS INCORPORATED, P O BOX 655474, M/S 3999, DALLAS, TX, 75265, US

(73) Assignee: Texas Instruments, Inc.

(21) Appl. No.: 11/648,948

(22) Filed: Jan. 3, 2007

(51) Int. Cl. H04Q 7/00

(52) U.S. Cl. 370/329; 455/452.1; 370/252; 370/338

(57) ABSTRACT

Automatic channel selection in a wireless network includes measuring throughput influencing factors for a plurality of wireless channels. A channel capacity metric is calculated for each of the plurality of wireless channels based on the measured throughput influencing factors. A serving channel is determined from the plurality of channels according to which channel capacity metric indicates a maximum channel capacity. Operation occurs in a normal operating mode using the determined serving channel for communication in the wireless network.

### TECHNICAL FIELD

This invention relates to communications, and more specifically automatic channel selection for a wireless communication system.

### BACKGROUND

A wireless network refers to any telecommunications network whose interconnections between nodes is implemented without the use of wires. A wireless local area network (WLAN) links two or more computers without using wires. WLANs and other wireless telecommunications networks are generally implemented with some type of information transmission system that uses electromagnetic waves, such as radio waves. The wireless nature of such networks allows wireless clients to access resources as well as to enable communication between wireless clients. With the continued decreasing cost associated with maintaining a wireless network, public wireless networks have emerged, such that users can employ a wireless client to access the internet from many locations by communicating with a wireless base station, typically referred to as access points.

Since the emergence of wireless networks, various protocols have been developed to define standardized forms of wireless communication. As one example, the IEEE 802.11 standard defines an industry standard protocol that permits a WLAN to be configured in a business or residence. The WLAN includes one or more access points located at predetermined locations and are connected to servers and other types of network equipment through an associated distribution system. The distribution system can be a wired network (e.g., a wired LAN) as well as employ other types of connections, including a wireless connection. Each access point also has a wireless radio capability to permit wireless communications with wireless clients, such as desktop computers, notebooks, handheld devices, electronic appliances and the like. Each access point has a certain range and a wireless-enabled device must be within that range for effective communications to occur. Through the access points, the wireless-enabled devices can gain access to the network for data and file transfers, email, etc. The wireless enabled devices can also communicate with each other through the access point.

### SUMMARY

One embodiment of the present invention includes a method for automatic channel selection in a wireless network. The method includes measuring throughput influencing factors for a plurality of wireless channels. A channel capacity metric is calculated for each of the plurality of wireless channels based on the measured throughput influencing factors. A serving channel is determined from the plurality of channels according to which channel capacity metric indicates a maximum channel capacity. Operation occurs in a normal operating mode using the determined serving channel for communication in the wireless network.

Another aspect of the invention provides an access point in a wireless network, which includes a processor and memory, the access point being programmed for performing an automatic channel selection. An initial automatic channel selection method is performed prior to initiating normal operation of the access point, the initial automatic channel selection method selecting a serving channel based on channel capacity metric calculated for a plurality of nonserving channels in the wireless network. An in-service automatic channel selection method that is performed after initiating normal operation of the access point. The in-service automatic channel selection method includes calculating a value of an in-service channel capacity metric for the serving channel based on values of throughput influencing factors determined for the serving channel. The in-service method also includes switching from the serving channel to a new serving channel candidate of the plurality of wireless channels based on the value of the in-service channel capacity metric for the serving channel relative to channel capacity metrics calculated for at least a portion of the plurality of wireless channels.

Yet another aspect of the present invention includes a system for performing automatic channel selection in a wireless network. The system includes a processor memory having computer-executable instructions for execution by the processor. The executable instructions include a measurement process operative to measure throughput influencing factors for a plurality of channels in the wireless network The instructions also include a channel capacity calculator operative to calculate at least one channel capacity metric for the plurality of channels as a function of the measured throughput influencing factors. The instructions also include an automatic channel selection manager that employs the measurement process and the channel capacity calculator to select a serving channel for the system. The manager controls the measurement process and the channel capacity calculator to perform one of an initial automatic channel selection method or an in-service channel selection method according to an operating mode of the system.

### BRIEF DESCRIPTION OF THE DRAWINGS

FIG. 1 depicts and example of a wireless network that can implement automatic channel selection according to an aspect of the invention.

FIG. 2 depicts an example of an automatic channel selection method according to an aspect of the invention.

FIG. 3 depicts an example of an initial automatic channel selection method according to an aspect of the invention.

FIG. 4 depicts an example of a non-serving channel capacity calculation that can be implemented according to an aspect of the invention.

FIG. 5 depicts an example of an in-service automatic channel selection method according to an aspect of the invention.

FIG. 6 depicts an example of a serving channel capacity calculation that can be implemented according to an aspect of the invention.

FIG. 7 depicts an example of a nominal noise calculation method that can be implemented according to an aspect of the invention.

FIG. 8 depicts an example of a system that can perform automatic channel selection in accordance with an aspect of the invention.

### DETAILED DESCRIPTION

This invention relates to systems and methods for Automatic Channel Selection (ACS). The present invention is applicable to a variety of wireless technologies, although examples and embodiments are described herein in the context of a wireless local area network (WLAN). As described herein, the ACS takes into account throughput influencing factors to select an operational channel that affords increased throughput. A variety of factors can influence the possible throughput of the WLAN communication, such as including channel noise and channel load. Other throughput influencing factors include contention on channel between WLAN nodes, co-located Basic Service Sets (BSSes) and the need to perform Extended rate PHY (ERP) protection, such as to enable interoperation with legacy WLAN devices. Radar operation on the channel can also lead to a seizure of the WLAN activity, such as can decrease the effective throughput on the channel.

As used herein, the term “channel noise” relates to energy detected by a receiver in the channel (in-band frequency range). Example sources of channel noise can include microwave ovens, cordless telephones, Bluetooth devices. Channel noise can limit a communication rate set, can reduce the communication area coverage as well as lead to higher Packet Error Rate (PER).

As used herein, the term “channel load” can be characterized by a relative time that co-located BSSes make use of a given channel. The usage of the given channel by collocated BSSes can limit the transmission opportunity of the devices in the BSS of interest.

Contention can be observed when multiple WLAN devices that use DCF/EDCA access operate on a given channel. Contention can be mitigated by employing increased number of retransmissions and longer backoff intervals required to access the channel, such as according to 802.11 media access rules. This can limit the total time the channel is available for transmission from a single device (e.g., an access point) standpoint. Co-located BSSes supporting EDCA can also limit the transmit opportunity possibility, since low Advanced Inter-Frame Space (AIFS) and Contention Window (cw) values of the channel access lead to a shorter backoff interval.

ERP Protection can be required when legacy WLAN devices from the co-located BSSes operate on the channel, such as operating according to an 802.11g protocol. ERP Protection leads to a longer packet transmission time due to the need to precede the data packet with control packet(s) protecting the medium from the transmission by the legacy devices. Longer packet transmission time influences the channel utilization.

The ACS methods and systems described and claimed herein can select a working (or serving) channel based on these (or a subset of these) throughput influencing factors. The ACS methods can be employed in an initial operation, such as at power-up or reset, which is referred to herein as “initial ACS.” The ACS methods and systems can also be implemented during normal operation, which is referred to herein as “in-service ACS.”

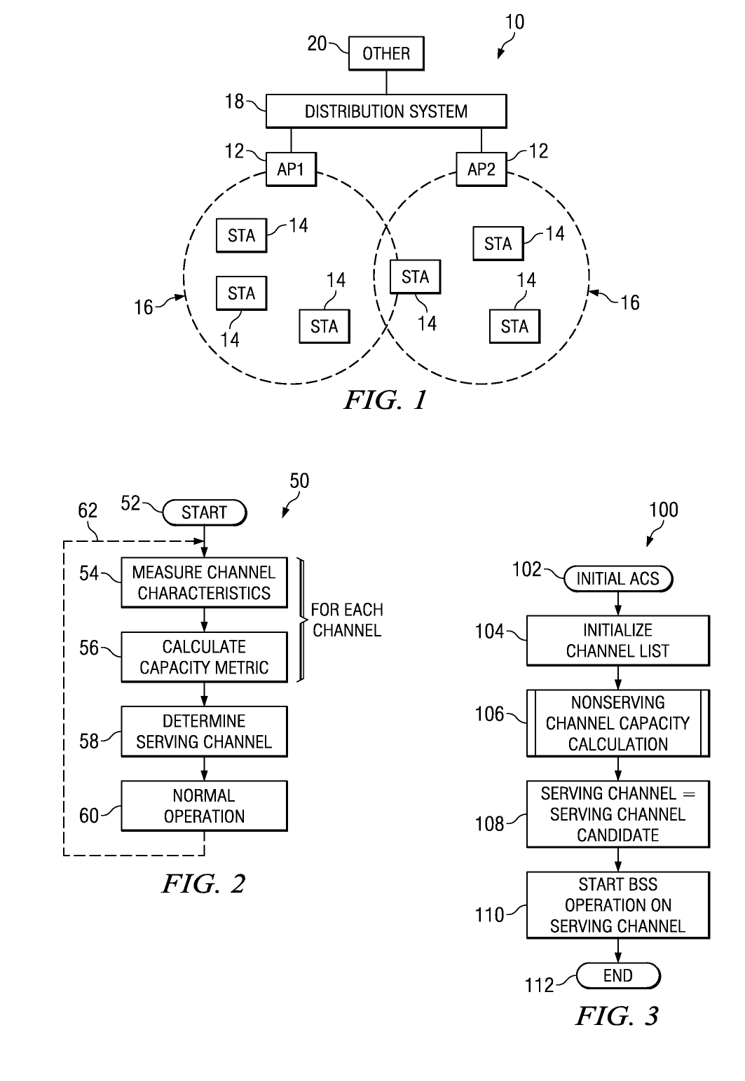

FIG. 1 depicts an example of a wireless communication system 10 that can implement ACS according to an aspect of the invention. All components that can connect into a wireless medium in a network can be referred to as stations. In the system 10, two types of stations are depicted: base stations 12 and wireless clients 14. Wireless clients 14 can be mobile devices, such as laptops, personal digital assistants (PDAs), IP phones or fixed devices, such as desktops and workstations that are equipped with a wireless network interface card. As used herein, the wireless clients 14 are referred to as stations (STAs) and the base stations 12 are referred to as access points (APs). Except for as otherwise described herein, the description of STAs 14 and APs 12 and their operation in a WLAN are intended to be consistent with how such terms are utilized in the various IEEE 802.11x standards. That is, each of the APs and STAs include hardware and software configured and programmed for normal operation in the system 10 as would be known by those of ordinary skill in the art.

The system 10 can include one or more AP 12. In the example of FIG. 1, the system 10 includes two access points 12, indicated at AP1 and AP2. Each access point 12 has a wireless coverage area 16 that defines a basic service set (BSS). The Basic Service Set (BSS) thus includes a set of all stations (APs and STAs) that can communicate with each other. Adjacent coverage areas can overlap geographically, such as to prevent dead or silent areas in which connectivity to the WLAN system is lost. The system 10 also includes a distribution system 18, such as can be a wired network (e.g., a wired LAN) as well as can employ other types of connections, including a wireless connection. The distribution system 18 can connect the APs 12 together as well as provide connections to other networks and servers, schematically depicted at 20.

While much of the following description will discuss the ACS as being implemented by an AP implemented in a WLAN, such as according to an 802.11x protocol, it will be understood that the systems and methods described herein can be implemented according to other existing and yet-to-be-developed industry standards as well as proprietary protocols. Examples of some such standards include Wi-Fi, Wi-MAX, and HyperLAN to name a few.

One or more AP 12 can be programmed and/or configured to implement ACS to dynamically select a channel for its associated BSS 16 according to an aspect of the invention. The AP 12 can implement the ACS based on measurements designed to ascertain throughput influencing factors for each of the channels, such as the factors described herein. The channels for a given AP 12 can be enumerated in a channel list. The goal of ACS is to select a working frequency that allows the WLAN BSS operation with maximum throughput.

FIG. 2 depicts an example of a general ACS method 50 that can be implemented by an AP (e.g., one of the APs 12 in FIG. 1) to select a serving channel for communication in the WLAN according an aspect of the invention. The method is applicable to both initial ACS as well as in-service ACS. The method starts at 52, such as will vary according to the type of ACS being implemented, initial or in-service ACS. For example, initial ACS can begin at power up or upon reset. In-service ACS can be implemented during normal operation, for example, periodically or in response to a trigger event, such as described herein. It will be understood that the method 50 can employ different processes (e.g., different measurements and different calculations) according to whether the method is being performed as part of an initial ACS method or an in-service ACS method.

At 54, one or more throughput influencing factors are measured, such as those factors listed above. The measurements at 54 can be performed over predefined intervals during a measurement process of the ACS. As an example, the measurements can be performed by the access point autonomously or by the stations that belong to a given BSS or by any combination thereof. For sake of consistency and simplicity of explanation, the following examples and embodiments will presume that the measurements, calculations and other functions are performed by the AP. For instance, the measurements can be performed by the AP for the purpose of implementing ACS. Alternatively or additionally, the measurements can be defined as part of a corresponding standard protocol (e.g., 802.11x), such as can provide for one or more stations with an ability to perform measurements at the request from the AP. Additionally, more than one measurement can be obtained for some or all of the throughput influencing factors. The measurements performed at 54 can also include post processing of measurement data, such as may include additional computations based on measured parameters.

By way of further example, channel noise measurements can be performed as part of the measurements at 54 to determine the level of the in-channel noise (e.g., results provided and stored in memory in dBm). The channel load measurement can be implemented as part of the measurement at 54 to determine the time wireless medium on the measured channel is in use co-located BSSes. Contention measurements can be performed reflected by number of WLAN nodes (including both AP and STA) present on the channel. Additionally, the fact that co-located BSSes support Enhanced Distributed Channel Access (EDCA) can be established as part of the measurements at 54, such as by monitoring the beacon frames on the channel. For instance, beacon frame containing Wi-fi multimedia (WMM) information element indicates that EDCA is supported by the BSS. Enhanced-rate PHY (ERP) Protection is used on a channel if Beacons belonging to the co-located BSSes that contain ERP information element having a predefined protection bit set accordingly. Thus, information elements in the beacon frame can be utilized to determine and to identify certain measurements available that can be included in the measurements at 54 implemented in the ACS method 50.

At 56, a channel capacity metric is calculated. The channel capacity metric is calculated based on one or more measurements of factors that influence channel throughput in the WLAN (e.g., measured at 54). The channel capacity metric thus reflects the available throughput that can be reached on a given channel, taking into account one or more throughput influencing factor (e.g., channel noise, channel load, ERP protection, etc). As used herein, the channel capacity metric can be computed as a value to indicate an affirmative channel capacity or, alternatively, the channel capacity metric can be calculated to indicate a channel capacity loss for the channel. As indicated by the bracket in FIG. 2, the measurements at 54 and calculations at 56 can be performed for each channel in the channel list or a subset of available channels.

At 58, a serving channel can be determined based on the calculated capacity metric. For instance, a best candidate serving channel can be determined as the channel having the maximum capacity (e.g., as calculated at 56). Such candidate serving channel can be selected as the serving channel and normal operation can begin (e.g., as in the case for initial ACS) or resume (e.g., as in the case for in-service ACS), as indicated at 60.

As mentioned above, the ACS method 50 can include an initial ACS process and an in-service ACS process. Initial ACS is performed before the BSS operation is started, such as at power up of the AP (e.g., implemented as part of a start-up operating mode). As part of the initial ACS, an initial channel capacity metric can be calculated at 56 for each channel from the channel list. The initial ACS can provide that the channel with highest channel capacity number is selected for normal BSS operation (e.g., corresponding to the beginning of a normal operating mode) at 60.

In-service ACS can be performed when BSS is operational. During normal operation, the method 50 can perform the in-service ACS, such as is schematically illustrated by the dashed line 62 returning from the normal operation block at 60 to the measurement block at 54. Thus, the in-service ACS includes performing a set of in-services measurements at 54 for current serving channel. Channel capacity metric for the current channel can be calculated at 56 periodically. When channel capacity decreases below the certain threshold that does not allow for networking applications to function properly (e.g., within expected operating parameters), for example, additional measurements can be obtained and the channel capacity metric can be calculated on the non-serving channels according to the channel list. Based on the channel capacity metric, a respective channel can be selected as the serving channel for operation. Prior to moving to a new channel in order to start the BSS operation there, the access point can seize BSS operation on the current channel by disassociating all Stations.

As described herein, the AP can be programmed and configured to perform measurements sufficient to calculate an indication of channel capacity at initial ACS and in-service ACS. The following description provides examples and embodiments for both initial ACS and in-service ACS, such as can be implemented in a WLAN environment by an AP. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., a computer or a processor-based device, such as an access point), software (e.g., as executable instructions running on one or more computer systems), or any combination of hardware and software.

FIG. 3 depicts an example of an initial ACS method 100. The method 100 begins at 102, such as at power up or reset of an AP, typically before the AP starts operation. The method begins in which parameters are instantiated to their starting values. At 104, a channel list is initialized. The channel list identifies the set of available channels for the AP (or other station) implemented the ACS method 100.

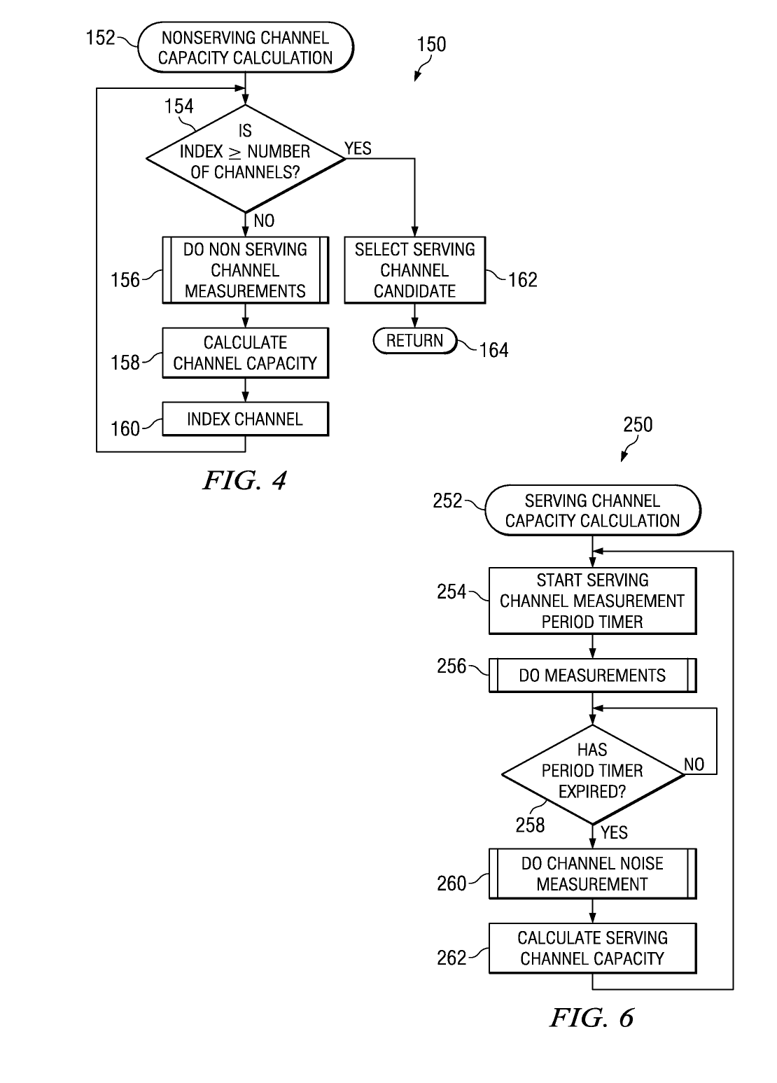

At 106, a non-serving channel capacity calculation process is performed (see, e.g., FIG. 4). The process at 106 thus includes performing measurements on the channels from the channel list. The process at 106 also calculates a channel capacity indicator value for each channel. The nonserving channel capacity calculation process returns a serving channel candidate, which identifies a channel determined to have a maximum channel capacity indicator value (e.g., also corresponding to the channel having a minimum channel capacity loss).

At 108, the serving channel candidate having the maximum channel capacity indicator value is set as the serving channel. At 10, the BSS operation is started on selected serving channel. Concurrently with starting BSS operation with the selected serving channel, the system time of the serving channel selection event can be stored in memory for a ServingChannelStarttime variable. The ServingChannelStarttime variable can be utilized for implementing subsequent in-service ACS, such as described herein. At 112, the initial ACS method 100 ends.

FIG. 4 is a flow diagram depicting an embodiment of a method 150 for performing nonserving channel capacity calculation (e.g., corresponding to block 106 in FIG. 3). The non-serving channel capacity calculation method can be called from the initial ACS (e.g., FIG. 3) and well as from an in-service ACS process. The method begins at 152, in which parameters for the calculation process 106 are initialized and loaded. For example, the parameters can include the channel list, measurement duration, and the number of respective measurements to be performed. Thus, an index for the channel list can be initialized to a starting value to facilitate and enable calculations of each channel.

At 154, a determination is made as to whether the channel index is greater than or equal to the number of channels. Provided that the index is not greater than or equal to the number of channels (NO), the method proceeds to 156. At 156, non-serving channel measurements are performed for the indexed channel. As described herein, the measurements at 156 can be executed on every one of the channels in the channel list that is input to the process. The channel list can include all available channels or a subset of such channels. As described herein, the measurements at 156 can include, for example, channel noise, nonserving channel load and ERP protection indication.

The measurements can be executed according to the measurement control parameters that are input to the method. By way of further example, the channel measurement process at 156 can employ control parameters that establish the duration and of the channel measurements as well as the number of measurements performed on each channel. For example, the measurements can be repeated a predetermined number of times (e.g., 5 times), such as can be user configurable. As an example, the sequence of measurements in each iteration can be as to first perform the channel noise Measurement and then measure nonserving channel load and ERP. After the sequence of measurements has been completed, additional channel noise measurements can be performed. The resulting nonserving channel load can be determined as the sum of individual nonserving channel load measurements. The resulting ERP can be determined as the logical OR of all individual ERP measurements. The resulting channel noise can be determined as the average of all individual channel noise measurements for the currently indexed channel.

At 158, the channel capacity indicator can be calculated for the indexed channel. The channel capacity indicator can be stored (e.g., in memory, such as a register in the AP) in conjunction with the channel index as to provide a serving channel candidate. From 158, the method proceeds to index the channel list at 160 so that the process (at 154, 156 and 158) can be repeated for the next indexed channel. In this way, a channel capacity indicator is determined for each channel in the channel list based on the results of the measurements for each respective channel.

If the index is greater than or equal to the number of channel input to the process (YES), indicating that the channel capacity calculation has been performed for all channels, the method proceeds to 162. At 162, a serving channel candidate is selected from the set of candidate channels according to which candidate has the highest channel capacity. The selected serving channel candidate can then be returned at 164 to the process that called the method (e.g., to the initial or in-service ACS process).

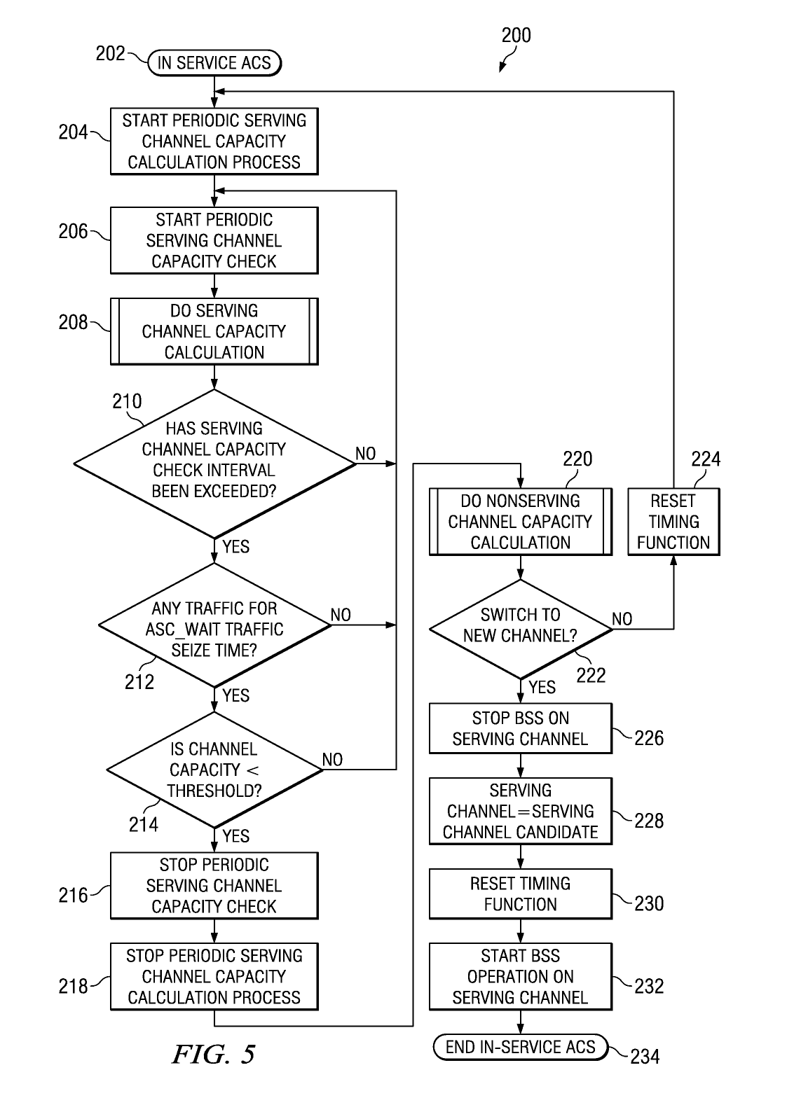

FIG. 5 depicts an example embodiment of an in-service ACS method 200 that can be implemented according to an aspect of the invention. The in-service ACS method can be performed after the AP begins operation of BSS(es). The in-service ACS can be implemented in a manner to mitigate disruption of service. The AP can check serving channel capacity periodically. For instance, if channel capacity for the serving channel degrades significantly (e.g., its channel capacity degraded below a threshold) and no traffic is present in the selected ACS for some time, appropriate circumstances exist for performing evaluating whether to switch from the serving channel to a new channel. If a newly selected channel has better channel capacity then it can be selected for the operation as a new serving channel.

The method begins at 202, such as in response to an in-service periodic timer indicating an appropriate time to begin the process. For example, while the AP is operating in-service mode (e.g., during normal operation), a periodic serving channel capacity process can be performed at 204. A serving channel capacity check interval can be established at 206 to define the periodic interval utilized to check serving channel capacity process that is performed at 204. The interval can be a duration of time from the serving channel start time (from the initial ACS process) or from the time a preceding in-service serving channel capacity check was performed.

At 208, periodic serving channel capacity calculation can be performed, such as described herein (see, e.g., FIG. 6). From 208, the method proceeds to 210 in which a determination is made as to whether more time than the serving channel capacity check interval has elapsed since the serving channel start time. If more time than the check interval has not elapsed (NO), the method returns to 206. When more time than serving channel capacity check interval is passed from the time the serving channel start time system variable was last updated (YES at 210), the method proceeds to 212. At 212, another determination is made as to whether traffic has been observed on access categories from an ACS_INSERVICE_CONSIDER_AC list for the ACS_WAIT_TRAFFIC_SEIZE_TIME. If traffic has been observed, the method returns to 206. If no traffic has been observed for the wait traffic seize time, the method can proceed to 214.

At 214, a determination is made as whether the serving channel capacity has degraded below a corresponding threshold. For example, the serving channel capacity (calculated periodically at 208) can be compared relative to a predetermined threshold for the serving channel capacity. If the capacity has not degraded to below the threshold, the method can return to 206. In contrast, if the serving channel capacity degrades below the threshold, the method proceeds to 216. That is, if the condition at 214 is met (e.g., indicating that the threshold has been met) then the decision to explore the possibility to switch to another channel is taken.

At 216, the method can include stopping the periodic serving channel capacity calculation process and, at 218, stopping the periodic serving channel capacity check process. At 218, a nonserving channel capacity calculation process can be performed (e.g., see FIG. 4). The process at 220 can be performed for a set of one or more nonserving channels, such as provided in the channel list that is input to the process. The list of channels utilized in such calculation may not contain the serving channel number. For instance, the channel list provided as an input to the nonserving channel capacity calculation process at 220 can explicitly exclude the current serving. As described herein (e.g., see FIG. 4), the nonserving channel capacity calculation process returns a serving channel candidate, which corresponds to the non-serving channel with a maximum value of channel capacity indicator. For instance, the process 220 can return as an output (e.g., stored in memory) an identification of the serving channel candidate (e.g., channel number) along with the value of the channel capacity computed by the process.

At 222, a determination is made as to whether to switch from the current serving channel to a new channel, namely the serving channel candidate determined by the process at 220. The determination at 222 can be performed by comparing the channel capacity for the serving channel candidate relative to the channel capacity computed for the serving channel. As one example, the computed capacity for the serving channel capacity can be multiplied by a switch factor to provide a computed value (e.g., SWITCH_FACTOR* ServingChannel Capacity). The switch factor can be a predefined value to control switching (e.g., switch factor≧1.0), which may be user programmable. If the computed value for the serving channel candidate is less than the channel capacity value for the serving channel, the decision at 222 is to remain on the serving channel and the method proceeds to 224. At 224, the serving channel start time is reset to the current system time. If the computed value for the serving channel candidate is greater than the channel capacity value for the serving channel, then the serving channel can be changed and the method proceeds to 226.

If serving channel is to be changed, at 226, the AP's operation on current serving channel is terminated. For instance, the AP can disassociate the one or more stations belonging to all BSSes served by the AP, effectively stopping BSS operation. At 228, the serving channel candidate can be set as the new serving channel. The timing function further can be adjusted at 230 to reset the interval for a next cycle of the serving channel capacity calculation process (e.g., at 208), such as by updating the ServingChannelStarttime variable with current system time value. The AP can begin BSS operation on the new serving channel at 232 and the in-service ACS method ends at 234. It will be appreciated that the in-service ACS will periodically perform the calculations at 204, 206 and 208 to determine whether to search for a better serving channel, as described herein.

FIG. 6 depicts an example of a method 250 for calculating serving channel capacity, such as can be called as part of an in-service ACS process. The method begins at 252 and can be performed periodically. For instance, as mentioned above, the serving channel capacity calculation process can be called from the in-service ACS periodically, such as based on the current system time relative to the time defined by the ServingChannelStarttime variable.

At 254, a serving channel measurement period timer is started. The timer can be set a predetermined duration that establishes an in-service measurement period. The measurements performed for in-service ACS can be the same or different from the measurements executed for initial ACS. At 256, a measurement process is called. The measurement process, for example, includes a sequence of measurements designed to obtain information sufficient to determine the serving channel load, the ERP protection indication and channel noise. For example, the sequence of measurements in each iteration can be to first perform the channel noise measurement and then execute measurements for serving channel load and an indication of ERP protection. At 258, a determination is made as to whether the timer has expired. If the timer has not expired (NO), the measurement sequence initiated at 256 can continue by the method looping at 258 until the timer expires. Upon determining that the timer has expired (YES), the method proceeds to 260 in which additional channel noise measurements are performed according to a predefined channel noise measurement process. To mitigate disruption to the service being provided on the serving channel, the measurements can be implemented in a non-service intrusive manner. The resulting serving channel load can be determined as the sum of individual serving channel load measurements. The resulting ERP can be determined as a logical OR of all individual ERP measurements. The resulting channel noise can be determined as the average of the individual channel noise measurements.

From 260, the method proceeds to 262 to calculate a value for the serving channel capacity indicator, such as described herein. The calculated value for the serving channel capacity indicator can be stored in memory and utilized in the in-service ACS, as described herein. Serving channel capacity represents the long-term monitored channel condition, such as can be performed periodically (e.g., as determined by a serving channel measurement period timer). To de-emphasize short term fluctuations, the serving channel capacity can be calculated as a weighted average. From 262, the method can return to 254 in which the in-service periodic method can be repeated for periodically computing the serving channel capacity metric.

The initial and in-service ACS process can employ a plurality of measurement processes that provide a quantitative indication of the throughput influencing factors based on which ACS occurs. Examples are provided herein for measurement processes that can be utilized to obtain values that represent channel noise, channel load, ERP protection indication, an indication of co-located EDCA BSSes, and contention. These values can be computed and utilized to compute the channel capacity metric for both initial ACS and in-service.

The channel noise measurements can be acquired by a process running in the AP that is programmed to calculate a nominal channel noise value. As mentioned above, channel noise measurements can be employed in both initial ACS and in-service ACS.

As one example, the channel noise measurement can be performed by collecting data and populating a channel noise histogram report for each channel with corresponding noise measurement data. Table 1 depicts an example of a channel noise histogram report that can be generated based on noise measurements. The noise histogram report of Table 1 contains the RPI (Receive Power Indication) densities observed in a given channel over a set of different RPI levels. Associated with each RPI level is corresponding bin that can be incremented for each noise measurement falling within the respective RPI level. The report thus will describe which RPI level a given noise measurement resides, such that aggregate set of noise measurements defines the histogram report for the given channel. In the example of Table 1, there are nine RPI levels (indicated at RPI 0 through RPI 8), although other numbers of RPI levels could be utilized.

TABLE 1

| | RPI 0 | RPI 1 | RPI 2 | RPI 3 | RPI 4 | RPI 5 | RPI 6 | RPI 7 | RPI 8 |
|---|---|---|---|---|---|---|---|---|---|
| | Density | Density | Density | Density | Density | Density | Density | Density | Density |
| Octet | Bin 0 | Bin 1 | Bin 2 | Bin 3 | Bin 4 | Bin 5 | Bin 6 | Bin 7 | Bin 8 |

The RPI levels can be defined for the noise histogram, such as by setting ranges for the RPI levels. Table 2 provides an example definition for the RPI levels (in dBm) for use with the noise histogram report shown in Table 1.

TABLE 2

| RPI | RPI Level (dBm) |
|---|---|
| 0 | RPI ≦ −92 |
| 1 | −92 < RPI ≦ −87 |
| 2 | −87 ≦ RPI ≦ −82 |
| 3 | −82 ≦ RPI ≦ −77 |
| 4 | −77 ≦ RPI ≦ −72 |
| 5 | −72 ≦ RPI ≦ −67 |
| 6 | −67 ≦ RPI ≦ −62 |
| 7 | −62 ≦ RPI ≦ −57 |
| 8 | −57 < RPI |

The noise histogram report can be populated with noise measurement data based on measurements performed at the AP as part of the ACS process. For the duration of each channel noise measurement, no downlink traffic is allowed over the channel. As an example, the AP can obtain data for the histogram by performing noise measurements that include sending a clear-to-send to itself (CTS-to-Self) for a duration (e.g., a channel noise measurement duration), such as can be programmable. The duration, for example can have default time (e.g., Default=1024 μsec). When associated hardware indicates CTS-to-Self was transmitted, a register value can be read to retrieve an indication of the receive power. For example, the register can be established in the AP to store Rx in-band power or Rx AGC. The register value can be read periodically, such as a fraction of the channel noise measurement duration (e.g., having a default of approximately 4 μsec). The channel noise measurement process can employ a conversion function to convert the register value to appropriate units (e.g., dBm) and increment the RPI Density bin matching the range where the received noise value resides. This process can be repeated to generate a corresponding noise histogram report for each channel. Those skilled in the art will understand and appreciate various approaches that can be employed to generate a noise histogram report or other set of noise measurements that can be employed as part of the ACS process according to an aspect of the present invention.

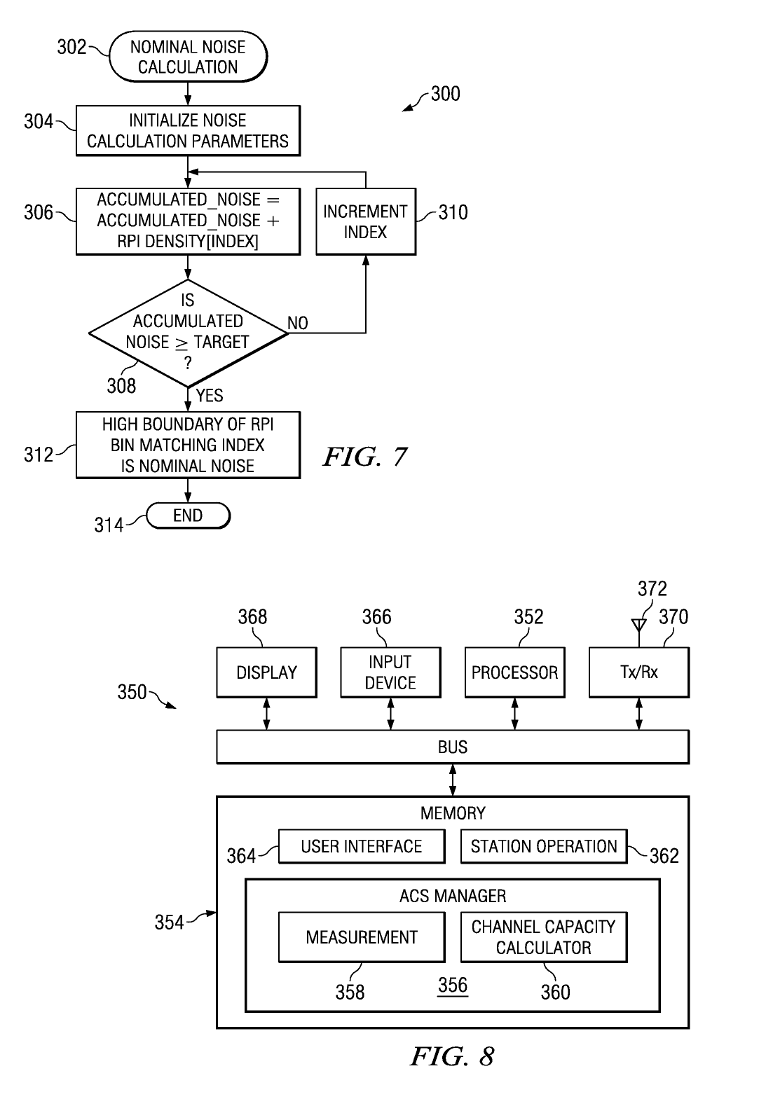

The channel noise measurement can also include a channel noise calculation that determines an indication of a nominal channel noise figure based on the data from the noise histogram report. FIG. 7 depicts an embodiment of a nominal noise calculation method 300, such as can be performed as part of a channel measurement implemented in the ACS process (initial ACS as well as in-service ACS).

The method 300 begins at 302, such as part of a larger noise measurement process, as described herein. The nominal noise calculation receives as inputs the noise histogram report and a noise persistence value, such that the nominal noise for a given channel is computed as a function of the noise histogram report. At 304, noise calculation parameters are initialized. For example, a method index for the histogram can be set to zero, accumulated noise can be initialized to zero and a target value for accumulated noise can be set equal to the noise persistence times a measurement factor. For instance, the measurement factor can be set according to the amount the noise register value is read during the channel noise measurement duration.

At 306, the accumulated noise is recalculated as the accumulated noise value plus the RPI density for the current index value of the noise histogram report. At 308, a determination is made as to whether the accumulate noise value is equal to or greater than the target accumulated noise. If the accumulated noise is not equal to or greater than the target accumulated noise (NO), the method proceeds to 310 in which the index is incremented to the next RPI bin. From 310, the method returns to 306 to recalculate the accumulated noise value. If the accumulated noise is at least equal to the target accumulated noise (YES), the method proceeds to 312. At 312, the high boundary of the RPI bin matching the current bin index (see, e.g., Table 2) is set as the nominal noise value. The process 300 then ends at 314.

From FIG. 7, it will be appreciated that the noise level that is the P^{th} percentile can be determined from the noise histogram report, where the P^{th} percentile noise level can be defined as the nominal channel noise (nominal noise) that corresponds to a substantially persistent noise level. The P^{th} percentile can be set to a value, for example, according to the expected target packet error rate (PER). For example, assuming that the PER is about 0.1, the P^{th} percentile can be set to provide a noise persistance corresponding to the P⁹⁰ percentile. In this example, the nominal noise level thus is defined as the noise level that was greater than or equal to the noise levels of 90% of the measurements (e.g., noise persistence set equal to 0.9). Stated differently, it means that 90% of the time the SNR (signal to noise ratio) measurements were higher than the nominal SNR which is related to the nominal noise.

As described herein, the measurement process implemented by the ACS can also measure and provide a value indicative of the non-serving channel load, such as based on sensing use of a non-serving channel. The non-serving channel load measurement can be performed as part of initial ACS and in-service ACS, as described herein. As one example, the non-serving channel load can correspond to an amount of time a given channel is busy, such as based on the assertion of a Clear Channel Assessment (CCA) signal. For example, according to 802.11 standards, the CCA can be implemented as a logical function that determines the current state of wireless channel, such that the CCA signal can be asserted for a given channel at times when no activity on such channel is sensed and de-asserted when activity on the channel is sensed.

The measurements for the non-serving channel load can acquire data over a predetermined channel load time interval, which can be the same or different during initial ACS and in-service ACS (e.g., Initial ACS=0.2 sec, In-Service ACS=0.3 sec). By way of further example, to obtain a non-serving channel load value, a busy time value can be accumulated from a register (e.g., a CCA_BUSY register) in the access point for the channel load duration time interval. The non-serving channel load thus corresponds to a medium busy time (value in μSec). The medium busy time further that can be normalized to a one-second time interval (e.g., non-serving channel load=Medium Busy/channel load duration time interval) or to other appropriate time scales.

For the in-service ACS, an additional indication of channel load can be determined, namely, the serving channel load. The serving channel load can be determined as the time the channel is busy in the WLAN by operation on non-current BSS. For example, the serving channel load can be determined as a function of the time that the CCA signal was not asserted and the time used to receive and transmit frames for current AP is not accounted for. The serving channel load measurement can be performed as part of in-service ACS for the predetermined time period (e.g., a serving channel measurement period), which period can be programmable. As an example, the serving channel load measurement process can include the following:
1. Accumulate a Medium Busy time a corresponding register value in μSec (e.g., from the CCA_BUSY register);
2. Accumulate a value (MediumUsageByCurrentAP) indicative of medium usage by the current access point. For instance, a MediumUsageByCurrentAP value can be calculated as the sum of PLCP Length field values in unicast received packets with Address1 equal to one of the BSSIDs that the AP is configured with (value in μSec ) as well as frame-exchange sequence overhead (e.g., the preamble duration of the unicast received packets, and the SIFS and 802.11 ACK duration).
3. Similar to the non-serving channel load measurement, the Serving Channel Load can also be normalized, such as to a one-second time interval as follows:

$$serving channel load = \frac{\begin{matrix}( Medium Busy - \\ MediumUsageByCurrent AP )\end{matrix}}{serving channel measurement period}$$

As mentioned above, the measurement process for ACS further can include an ERP Protection measurement function. The ERP Protection Measurement function provides an indication as to whether ERP Protection has been forced by one or more co-located BSSes. As is known in the art, ERP Protection decreases the channel throughput as it requires control frame transmitted before the data frame. ERIP Protection measurement can be performed as part of Initial and In-Service ACS.

As one example, an indication of ERP Protection for use in ACS can be obtained as follows:
1. A passive Scan can be performed on the channel, and the beacons of collocated BSSes are collected.
2. The beacon's ERP Protection information element can be analyzed. For example, the Use_Protection field can be employed as follows:
   a. if the Use_Protection field value=‘1’ then set ERP indicator equal to 1, and
   b. if none of the captured beacons contains a Use_Protection field set, then set ERP indicator equal to 0.
3. If beacon from the 802.11b BSS is received, then set ERP indicator equal to 1.

An additional measurement that can be employed is to determine if there are any Co-Located EDCA BSSes. This can be determined by employing a Co-Located EDCA BSSes measurement function. The Co-Located EDCA BSSes measurement function provides an indication as to whether result Co-located BSSes operate with EDCA access. As is known in the art, EDCA access generally uses short back-off times, thus limiting the opportunity to access the media for the given AP. The Co-Located EDCA BSSes measurement can be performed as part of both initial and in-service ACS.

The following is one example of a process that can be employed to obtain an indication as to whether result Co-located BSSes operate with EDCA access (the Co-Located EDCA BSS indication):
1. A passive Scan is performed on the channel to collect beacons of co-located BSSes.
2. The collected beacons are analyzed to determine the presence of a WMM information element, such as follows:
   a. If WMM information element is present, then set Co-located EDCA BSS indicator equal to 1; and
   b. If WMM information element is not present, set consider Co-located EDCA BSS indicator equal to 0.

Additionally, one or more contention measurements can be performed to ascertain the amount of stations (e.g., STA and AP) that do not belong to the current AP's BSS on the channel. This measurement is performed because if more nodes (AP and STA) are present, an increased possibility for contention exists. The contention measurement can be performed as part of Initial ACS to provide an indication of amount of contention for a given channel.

As one example, the contention measurement function for a given channel can be performed as follows:
1. The receive filter can be set to the promiscuous mode to receive all communications on the channel and
2. The unicast frames are received the number of unique transmitters is maintained as indication of the contention.

After the measurements have been performed, the ACS process calculates the channel capacity metric, such as based on an estimation of the channel capacity loss. The channel capacity loss can be computed differently for initial ACS and for in-services ACS. Generally stated, the channel capacity depends on the percentage of the time that the channel is not busy with signals from other BSSes, and on the channel noise when there are no interfering signals. The channel capacity in Mbps is linearly proportional to the channel load. Table 3 illustrates examples of receiver sensitivity level (in dBm) for the various data rates for OFDM, DSSS and CCK transmission schemes.

TABLE 3

| Data Rate | | Sensitivity |
|---|---|---|
| Scheme | Rate (Mbps) | (dBm) |
| OFDM | 54 | −71 |
| OFDM | 48 | −72 |
| OFDM | 36 | −76 |
| OFDM | 24 | −80 |
| OFDM | 18 | −83 |
| OFDM | 12 | −85 |
| OFDM | 9 | −88 |
| OFDM | 6 | −89 |
| CCK | 11 | −85 |
| CCK | 5.5 | −89 |
| DSSS | 2 | −91 |
| DSSS | 1 | −93 |

By way of further example, the following equations can be utilized by the channel capacity calculation to calculate channel capacity loss and channel capacity for the initial ACS:

$$Capacity {Loss}_{i} = \frac{( {N}_{i} - SL )}{z} \cdot ( 1 - {CL}_{i} ) + AR \cdot {CL}_{i}$$

where:

Nᵢ is the Nominal Noise for channel i;

SL is the sensitivity level of the lowest rate (e.g., −93 dBm or higher, as set forth below). SL can be software programmable (e.g., by a user);

z is the conversion ratio between dB to Mbps (1/2.4). This parameter can be software programmable (e.g., by a user);

CLᵢ is the channel load for channel i (i.e. the portion of time the channel is busy with 802.11 signals from other BSSes);

ChannelLoad is the result of the non-serving channel load measurement, such as described herein; and

AR is a coefficient that represents the expected PHY rate of the WLAN network as function expected operational range. The value of AR can be calculated as set forth below.

Given the capacity loss, the actual capacity is estimated, taking into account the influence of ERP on channel utilization, such as follows:

Actual Capacityᵢ=(AR−Capacity Lossᵢ)·LegacyLoss

where:

LegacyLoss=ERPfactor*ERPProtectionIndicator, and represents the additional capacity loss due to the need to transmit in non-OFDM, where:
ERPfactor is the factor of channel throughput decrease when ERP protection is required. This parameter can be calculated by estimating the actual PHY rate according to:

$$Actual PHY {Rate}_{i} = AR - \frac{( {N}_{i} - SL )}{z}$$

The estimated PHY rate is mapped onto an actually supported PHY rate and based on this the expected ERP overhead is calculated. The second term is the noise related rate degradation, and is included in the capacity loss calculation above. This parameter can also be software programmable (e.g., by a user).

The ERPfactor can include a default value (e.g., default=0.8), which corresponds to the expected overhead to transmit CTS-to-Self frames on 11 Mbps, short preamble);
ERPProtectionIndicator is the result of the ERP measurement;

AR can be obtained from a rate table, such as the example rate table provided in Table 4. For example, the AR=rate table[EXPECTED_RANGE]. The value of the EXPECTED_RANGE can be a value that represents an expected range for the AP. For instance, the range of Table 4 includes five discrete ranges (e.g., 1-5, where 1 represents minimal range, 5 represents maximum range of the BSS). The expected range can be an initialization time variable, which can also be user-configurable.

TABLE 4

| Expected Range | PHY Rate, Mbps |
|---|---|
| 1 | 54 |
| 2 | 36 |
| 3 | 24 |
| 4 | 11 |
| 5 | 2 |

A value for the parameter SL can be obtained from a table similar to Table 4, but with Sensitivity Level values instead of PHY rates values. This enables setting higher sensitivity levels for shorter expected ranges, thus taking into account the spare SNR margin and allowing some additional noise without actually decreasing the estimated capacity. For example, the SL=sensitivity table[EXPECTED_RANGE]. The same value of the EXPECTED_RANGE used above can also be used for the SL parameter.

The channel capacity loss and channel capacity for in-service operation can be calculated differently than for the initial ACS. For example, the in-service channel capacity measurements should be implemented to mitigate disruption of service for the BSS. Additionally, in-service calculation can be implemented to account for and historical or long term channel capacity characteristics. For example, the channel capacity loss for in-service operation can be calculated using the following equation:

Channel Capacity Loss=Channel Capacity Loss*(CCL_FORGETTANCE_FACTOR)+Last Capacity Loss*(1−CCL_FORGETTANCE_FACTOR)

where:

LastCapacityLoss is the result of the single Channel Capacity loss calculation, such as can be computed as follows:

$$Last Capacity Loss = \frac{( {N}_{i} - SL )}{z} \cdot ( 1 - {CL}_{i} ) + AR \cdot {CL}_{i}$$

and

CCL_FORGEYTANCE_FACTOR is in the range(0 . . . 1), default=0.8

Nᵢ is the nominal noise calculated for channel i;

SL is the sensitivity level of the lowest rate (−93 dBm or higher, as set forth above). This parameter can be software programmable (e.g., by a user);

z is the conversion ratio between dB to Mbps (1/2.4). This parameter can be software programmable (e.g., by a user);

CLᵢ is the channel load for channel i (i.e. the portion of time the channel is busy with 802.11 signals from other BSSes); and

AR represents the expected PHY rate of the WLAN network as function of the required operational range, such as can be calculated as mentioned above.

Given this smoothed channel capacity loss, the actual capacity is estimated, taking into account the influence of ERP on channel utilization, such as follows:

Actual Capacityᵢ=(AR−Channel Capacity Lossᵢ)·LegacyLoss

where:

LegacyLoss=ERPfactor*ERPProtectionlndicator, and represents the additional capacity loss due to the need to transmit in non-OFDM, where:
ERPfactor is the factor of channel throughput decrease when ERP protection is required. This parameter can be calculated by estimating the actual PHY rate according to:

$$Actual PHY {Rate}_{i} = AR - \frac{( {N}_{i} - SL )}{z}$$

The estimated PHY rate is mapped onto an actually supported PHY rate and, based on this mapping, the expected ERP overhead is calculated. The second term is the noise related rate degradation, and is included in the capacity loss calculation above. This parameter can also be software programmable (e.g., by a user). The ERPfactor can include a default value (e.g., default=0.8), which corresponds to the expected overhead to transmit CTS-to-Self frames on 11 Mbps, short preamble); and

ERPProtectionIndicator is the result of the ERP measurement.

FIG. 8 depicts an example embodiment of a system 350 that can perform ACS according to an aspect of the present invention. The system 350 can be an access point or a wireless client operating in a BSS. The system 350 can be programmed to perform ACS, such as including initial ACS, in-service ACS or a combination of both initial ACS and in-service ACS, such as according to any of the embodiments described herein.

In the example of FIG. 8, the station includes a processor 352 and memory 354, such as can be interconnected through a bus. The memory 354 can include RAM and ROM. The processor 352 thus executes instructions stored in the memory 354 for performing the ACS and other functions associated with operation of the system 350. For instance, the memory is programmed with an ACS manager 356 that is programmed to manage the ACS processes implemented by the system, including measurement processes, indicated by measurement block at 358 and channel capacity calculations, as indicated at 360. For example, the ACS manager 356 can also control the measurement process (via the channel capacity calculator 360) and the channel capacity calculator 358 to perform one of an initial automatic channel selection method or an in-service channel selection method according to an operating mode of the system (e.g., is the system 10 in a start-up mode or a normal in-service operating mode).

Those skilled in the art will understand and appreciate various measurements and associated calculations that can be performed based on the teachings contained herein, which can be implemented as program instructions in the measurement block 356. Additionally, the channel capacity calculations 360 can be used to compute channel capacity of one or more channels to enable the ACS manager to select a channel for BSS operation, such as based on the teachings contained herein. The memory 354 can also include a station operation block that is programmed to control and implement other processes associated with normal operation of the system 350.

A user interface 364 can also be employed, such as for programming parameters of the ACS manager 356 and adjusting other operating parameters of the station. One or more input device 366 can be coupled to the system 350 for programming or configuring the station, which can be employed to manipulate data and/or graphical features in the user interface (e.g., a graphical user interface) 364, such as can be shown on an associated display 368.

The system 350 can also a transceiver 370 that can be configured to transmit and receive wireless signals relative to the system 350, such as according to any known or yet to be developed transmission scheme (e.g., OFDM, DSSS, CCK and the like). The transceiver 370 is coupled to an antenna 372 to transmit and to receive desired data. The associated receive portion converts received signals into corresponding digital data. It will be appreciated that the example computer system 350 is for descriptive purposes only, as to provide context for implementing the various processes described herein, including the automatic channel selection processes.

What have been described above are examples and embodiments of the invention. It is, of course, not possible to describe every conceivable combination of components or methodologies for purposes of describing the invention, but one of ordinary skill in the art will recognize that many further combinations and permutations of the present invention are possible. Accordingly, the present invention is intended to embrace all such alterations, modifications, and variations that fall within the scope of the present application.

What is claimed is:

1. A method for automatic channel selection in a wireless network, comprising:
measuring throughput influencing factors for a plurality of wireless channels;
calculating a channel capacity metric for each of the plurality of wireless channels based on the measured throughput influencing factors;
determining a serving channel from the plurality of channels according to which channel capacity metric indicates a maximum channel capacity; and
operating in a normal operating mode using the determined serving channel for communication in the wireless network.

2. The method of claim 1, further comprising an initial channel selection method performed prior to beginning the normal operating mode, the initial channel selection method comprising:
performing measurements of the throughput influencing factors on each of a plurality of nonserving channels;
calculating the channel capacity metric as an indication of channel capacity for each of the plurality of nonserving channels;
selecting a serving channel candidate corresponding to which of the nonserving channels has a maximum indication of channel capacity; and
starting operation in the normal operating mode with the selected serving channel candidate defining the determined serving channel for communication in the wireless network.

3. The method of claim 1, further comprising an in-service automatic channel selection method performed during the normal operating mode, the in-service automatic channel selection method, comprising:
performing measurements of the throughput influencing factors on the serving channel of the plurality of wireless channels;
calculating a value of an in-service channel capacity metric for the serving channel based on the measured throughput influencing factors; and
switching from the serving channel to a new channel of the plurality of wireless channels based on the in-service channel capacity metric for the serving channel relative to channel capacity metrics calculated for at least a portion of a plurality of non-serving channels of the plurality of wireless channels.

4. The method of claim 3, wherein the measurements and the calculation of the in-service channel capacity metric for the serving channel are performed periodically relative to an event.

5. The method of claim 4, wherein the event comprises a most recent one of an initial automatic channel selection method and a preceding in-service automatic channel selection method.

6. The method of claim 3, further comprising:
comparing the calculated value of the in-service channel capacity metric for the serving channel relative to a threshold;
remaining on the serving channel if the comparison provides a first result; and
evaluating whether to perform the switching from the serving channel to the new channel if the comparison provides a second result.

7. The method of claim 6, wherein the threshold is programmable.

8. The method of claim 6, wherein if the comparison indicates to evaluate whether to perform the switching, the in-service automatic channel selection method further comprises:
calculating a value of the channel capacity metric for each of a plurality of nonserving channels based on corresponding measured throughput influencing factors for at least each of the respective non-serving channels.

9. The method of claim 8, wherein the in-service automatic channel selection method further comprises:
selecting a serving channel candidate according to which calculated value of the channel capacity metric indicates a relative maximum capacity; and
switching from the serving channel to the selected serving channel candidate based on the value of the in-service channel capacity metric for the serving channel relative to the value of the channel capacity metric for the selected serving channel candidate.

10. The method of claim 9, wherein the evaluation whether to perform the switching further comprises:
applying a switching factor to the value of the channel capacity metric for the selected serving channel candidate to provide a computed value; and
comparing the value of the in-service channel capacity metric for the serving channel with the computed value.

11. The method of claim 9, wherein the switching further comprises:
terminating service in the wireless network on the serving channel;
setting the serving channel to the selected serving channel candidate; and
starting normal operation in the wireless network.

12. The method of claim 1, wherein the throughput influencing factors comprise channel noise, channel load and an indication of extended PHY rate protection.

13. The method of claim 12, further comprising calculating the channel noise as a nominal noise value based on a histogram report constructed over a plurality of noise measurements.

14. An access point in a wireless network, comprising a processor and memory, the access point programmed for performing an automatic channel selection method comprising:
an initial automatic channel selection method that is performed prior to initiating normal operation of the access point, the initial automatic channel selection method selecting a serving channel based on channel capacity metric calculated for a plurality of nonserving channels in the wireless network;
an in-service automatic channel selection method that is performed after initiating normal operation of the access point, the in-service automatic channel selection method comprising:
calculating a value of an in-service channel capacity metric for the serving channel based on values of throughput influencing factors determined for the serving channel; and
switching from the serving channel to a new serving channel candidate of the plurality of wireless channels based on the value of the in-service channel capacity metric for the serving channel relative to channel capacity metrics calculated for at least a portion of the plurality of wireless channels.

15. The access point of claim 14, wherein the in-service automatic channel selection method further comprises:
comparing the calculated value of the in-service channel capacity metric for the serving channel relative to a threshold;
remaining on the serving channel if the comparison provides a first result; and
evaluating whether to perform the switching from the serving channel to the new channel if the comparison provides a second result.

16. The access point of claim 15, wherein if the comparison indicates to proceed with evaluating whether to perform the switching, the in-service automatic channel selection method further comprises:
measuring the throughput influencing factors for at least each of the non-serving channels to provide values for corresponding measured throughput influencing factors; and
calculating a value of the channel capacity metric for each of a plurality of nonserving channels based on the values for corresponding measured throughput influencing factors.

17. The access point of claim 16, wherein the in-service automatic channel selection method further comprises:
selecting a serving channel candidate according to which calculated value of the channel capacity metric indicates a relative maximum channel capacity; and
switching from the serving channel to the selected serving channel candidate based on the value of the in-service channel capacity metric for the serving channel relative to the value of the channel capacity metric for the selected serving channel candidate.

18. The access point of claim 16, wherein the throughput influencing factors for each of the plurality of channels comprise channel noise, channel load and an indication of extended PHY rate protection.

19. A system for performing automatic channel selection in a wireless network, comprising:
a processor;
memory having computer-executable instructions for execution by the processor, the executable instructions comprising:
a measurement process operative to measure throughput influencing factors for a plurality of channels in the wireless network;
a channel capacity calculator operative to calculate at least one channel capacity metric for the plurality of channels as a function of the measured throughput influencing factors; and
an automatic channel selection manager that employs the measurement process and the channel capacity calculator to select a serving channel for the system, the manager controlling the measurement process and the channel capacity calculator to perform one of an initial automatic channel selection method or an in-service channel selection method according to an operating mode of the system.

20. The system of claim 19, wherein the in-service automatic channel selection method further comprises executable instructions for:
employing the measurement process and the channel capacity calculator to determine a value of the in-service channel capacity metric for the serving channel;
comparing the value of the in-service channel capacity metric for the serving channel relative to a threshold;
remaining on the serving channel if the comparison provides a first result;
evaluating whether to perform the switching from the serving channel to the new channel if the comparison provides a second result, the evaluation further comprising:
measuring the throughput influencing factors for at least each of the non-serving channels to provide values for corresponding measured throughput influencing factors; and
calculating a value of the channel capacity metric for each of a plurality of nonserving channels of the based on the corresponding measured throughput influencing factors.

21. The system of claim 19, wherein the throughput influencing factors for each of the plurality of channels comprise channel noise, channel load and an indication of extended PHY rate protection.

22. The system of claim 19, wherein the measurement process further comprises executable instructions for calculating channel noise as a nominal noise value based on a histogram report constructed over a plurality of noise measurements.
